(19) United States
(12) Patent Application Publication
(10) Pub. No.: US 2026/0295555 A1
(43) Pub. Date: Oct. 1, 2026

(54) MICROWAVE REACTOR

(71) Applicant: MITSUBISHI ELECTRIC CORPORATION, Tokyo (JP)

(72) Inventors: Takumi SUGITANI, Tokyo (JP); Akira INOUE, Tokyo (JP)

(73) Assignee: Mitsubishi Electric Corporation, Tokyo (JP)

(21) Appl. No.: 19/478,357

(22) PCT Filed: Aug. 22, 2023
(86) PCT No.: PCT/JP2023/030188

§ 371 Date: Oct. 24, 2025

(51) Int. Cl. B01J 19/12

(52) U.S. Cl. CPC B01J 19/126; B01J 2219/1215; B01J 2219/1263; B01J 2219/1266; B01J 2219/1293

(57) ABSTRACT

A reactor (1) accommodates a reactant (2). A microwave generator (4) generates a microwave beam (5). An opening (3) is provided in the reactor (1). The microwave generator (4) concentrates the microwave beam (5) in a center portion of the opening (3) to cause the microwave beam (5) to enter an inside of the reactor (1). An inner wall of the reactor (1) reflects the microwave beam (5). A size of the opening (3) is longer than a half wavelength of the microwave beam (5). An area of the opening (3) is equal to or less than 1/10 of an area of a portion of the inner wall of the reactor (1) which is not covered with the reactant (2).

### FIELD

The present disclosure relates to a microwave reactor.

### BACKGROUND

In a conventional microwave reactor, a microwave is supplied to the inside of the reactor through a waveguide. Since the area of an opening of the waveguide is small, the amount of a reflected wave of the microwave which returns to the waveguide is small. The waveguide generates heat by a current which flows in a conductor of a wall of the waveguide; also, loss occurs in the waveguide. However, in the case where the reactor is not large in scale, a microwave at a level of several kW may be supplied, so that the heat generation and the loss which occur in the waveguide are at allowable levels. On the other hand, in a large-scale plant, it is necessary to supply a microwave having a high power of several hundred kW to several tens of MW, and thus the heat generation and the loss which occur in the waveguide cannot be ignored. For example, when a power of 1 MW at 2.45 GHz is made to pass through a waveguide WRI-26, heat generation of 3.7 kW occurs every 1 m, and a loss of 0.016 dB of a microwave, i.e., a loss of 3.7 kW occurs. Since the size of the cross section of the waveguide needs to be equal to or less than the half wavelength so that a higher-order mode does not occur, the waveguide WRI-26 has a cross section of 8.4 cm×4.2 cm, which is narrow. Because of this, a wall surface current of the waveguide which is generated when a 1 MW microwave propagates is concentrated and flows in a very small region less than or equal to 8 cm at most, and therefore, a great amount of heat and loss is generated.

In a chemical reactor, generally, a reactor is provided inside an explosion protection wall due to the need for explosion protection, and an oscillator is provided outside the explosion protection wall. Therefore, the actual length of the waveguide is 2 to 5 m or more. In the case where the length of the waveguide is 5 m, the heat generation and the loss are as high as 18.5 kW, which has been a problem in terms of both energy efficiency and heat exhaust design.

Furthermore, conventionally, the microwave is generated with an oscillator which uses a magnetron. However, the magnetron is inferior in frequency purity and phase stability, and it is difficult to combine microwaves from a plurality of magnetrons. Also, there is a limitation on the microwaves which can be generated with one magnetron, such as those equal to or less than 10 kw at 2.45 GHz, for example, and it is difficult to generate a microwave having a high power of greater than 10 kW. In addition, with a magnetron, the efficiency is decreased to 60% or less when the power is as high as 10 kW, and a high-power and highly efficient microwave cannot be generated. In response to this, an apparatus in which an antenna is provided inside a reactor without using a waveguide has been proposed (for example, see PTL 1).

### CITATION LIST

### Patent Literature

[PTL 1] JP 2017-103454 A

### SUMMARY

### Technical Problem

However, a microwave reflected by an inner wall of the reactor returns to the antenna directly and a device such as an amplifier which supplies the microwave to the antenna is damaged in some cases. In view of this, an isolator which prevents a reflected wave is provided between an output of the amplifier and the antenna. However, in the case of performing microwave irradiation of high power which is equal to or greater than several hundreds of W, the isolator is difficult to place because of the increase in size of the isolator, and the cost of the isolator is increased. For example, when microwave irradiation of high power such as that greater than 10 kW at 2.45 GHz is performed, the damage to the device due to the reflected wave becomes a problem.

The present disclosure is made to solve the above-described problems, and an object thereof is to obtain a microwave reactor which can prevent damage to a device due to a reflected wave even when high-power microwave irradiation is performed.

### Solution to Problem

A microwave reactor according to the present disclosure includes: a reactor accommodating a reactant; and a microwave generator generating a microwave beam, wherein an opening is provided in the reactor, the microwave generator concentrates the microwave beam in a center portion of the opening to cause the microwave beam to enter an inside of the reactor, an inner wall of the reactor reflects the microwave beam, a size of the opening is longer than a half wavelength of the microwave beam, and an area of the opening is equal to or less than 1/10 of an area of a portion of the inner wall of the reactor which is not covered with the reactant.

### Advantageous Effects of Invention

In the present disclosure, in a configuration which causes the microwave beam to enter the inside of the reactor directly without using a waveguide, the area of the opening of the reactor is equal to or less than 1/10 of the area of the portion of the inner wall of the reactor which is not covered with the reactant. Accordingly, even with high-power microwave irradiation, the damage to the device due to the reflected waves can be prevented.

### BRIEF DESCRIPTION OF THE DRAWINGS

FIG. 1 is a cross-sectional view showing a microwave reactor according to Embodiment 1.

FIG. 2 is a cross-sectional view showing a microwave reactor according to Embodiment 2.

FIG. 3 shows a calculation result of spatial combining of microwaves from a rectangular array antenna.

FIG. 4 shows a calculation result of spatial combining of microwaves from a rectangular array antenna.

FIG. 5 shows a circular array antenna.

FIG. 6 shows a calculation result of spatial combining of microwaves from the circular antenna.

FIG. 7 shows a calculation result of spatial combining of microwaves from the circular array antenna.

FIG. 8 is a circuit diagram of the oscillator of the microwave reactor according to Embodiment 3.

FIG. 9 is a circuit diagram of an oscillator according to the comparison example.

FIG. 10 is a cross-sectional view showing a microwave reactor according to Embodiment 4.

FIG. 11 is a cross-sectional view showing a microwave reactor according to Embodiment 5.

FIG. 12 is a cross-sectional view showing a microwave reactor according to Embodiment 6.

### DESCRIPTION OF EMBODIMENTS

A microwave reactor according to the embodiments of the present disclosure will be described with reference to the drawings. The same components will be denoted by the same symbols, and the repeated description thereof may be omitted.

### Embodiment 1

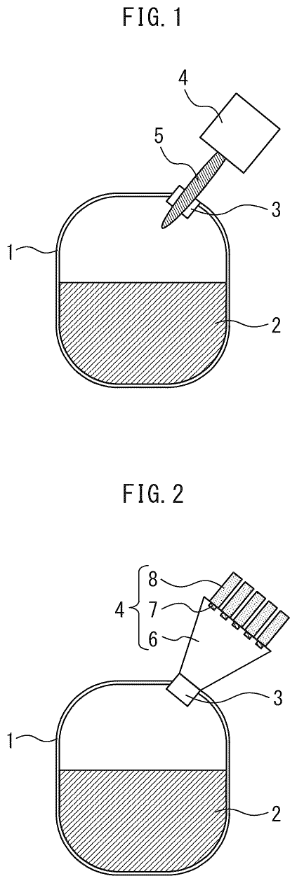

FIG. 1 is a cross-sectional view showing a microwave reactor according to Embodiment 1. A reactor 1 accommodates a reactant 2. An inner wall of a lower portion of the reactor 1 is covered with the reactant 2. An opening 3 is provided in an upper portion of the reactor 1 which is not covered with the reactant 2. The microwave generator 4 generates a microwave beam 5 which is an electromagnetic wave of a microwave. The frequency of the microwave is from 0.9 GHz to 30 GHz, and the wavelength thereof is from 33 cm to 1 cm.

The microwave generator 4 is a horn antenna, for example, and causes the microwave beam 5 to enter the inside of the reactor 1 through the opening 3. The microwave which is caused to enter the inside of the reactor 1 is absorbed by the reactant 2, and, with the microwave, the reactant 2 undergoes a reaction such as a chemical reaction, burning, or drying.

Conventionally, a microwave is caused to enter a reactor through a waveguide, and the diameter of the waveguide is made equal to or less than the half wavelength because loss is increased when a higher-order mode occurs. In contrast, in this embodiment, the microwave generator 4 causes the microwave beam 5 to enter the inside of the reactor 1 directly without using a waveguide; thus, the size of the opening 3 can be made larger than the half wavelength of the microwave beam 5.

However, when the size of the opening 3 is larger than the half wavelength, a higher-order mode occurs in addition to a TE01 mode, which is a basic mode used for a waveguide, and the propagation efficiency is hindered. Accordingly, the microwave generator 4 concentrates the microwave beam 5 in a center portion of the opening 3 to cause the microwave beam to enter the inside of the reactor 1. Hence, an end portion of the opening 3 is hardly irradiated with the microwave, and a current does not flow at the edge of the opening 3; thus, it is possible to prevent heat generation and loss of the microwave at the feeding portion, which had been a problem in the case of using a waveguide.

Since the reactor 1 is made of metal such as stainless steel, the inner wall of the upper portion of the reactor 1 which is not covered with the reactant 2 reflects the microwave beam 5. Within the reactor 1, the microwave beam 5 is reflected multiple times, and is repeatedly absorbed into and reflected by the reactant 2. Thus, the reactant 2 in the reactor 1 can be irradiated with the microwave beam 5 comparatively uniformly.

The microwave beam 5 is substantially totally reflected by the inner wall of the reactor 1, and the inside of the reactor 1 exhibits electromagnetic field distribution such as that in which resonance occurs by multiple reflection. In this state, when the opening 3 having a small size is made in the reactor 1, a state like so-called black-body radiation is brought about. Among such microwaves, the amount of reflected waves that escape to the outside through the opening 3 is small, and is proportional to a ratio between the area of the inner wall of the upper portion of the reactor 1 which is not covered with the reactant 2 and the area of the opening 3. When the amount of the reflected waves is large, the amount of the microwaves that reach the reactant 2 is reduced and the efficiency of the reactor is decreased. Also, there is a possibility that the microwave generator 4 will be damaged by the reflected waves. Thus, the amount of the reflected waves needs to be limited to a very small amount which is equal to or less than one-tenth of the microwaves inside the reactor 1. As the area of the opening 3 is reduced, the amount of the reflected waves increases. Thus, in this embodiment, the area of the opening 3 of the reactor 1 is made equal to or less than 1/10 of the area of the portion of the inner wall of the reactor 1 which is not covered with the reactant 2. Accordingly, even with high-power microwave irradiation of greater than 10 kW, i.e., from 100 kW to several tens of MW, the damage to the device due to the reflected waves can be prevented.

### Embodiment 2

FIG. 2 is a cross-sectional view showing a microwave reactor according to Embodiment 2. In this embodiment, the microwave generator 4 includes a chamber 6, a plurality of antennas 7, and a plurality of oscillators 8. The chamber 6 is connected to the opening 3 of the reactor 1 and surrounds a space for forming the microwave beam 5. The chamber 6 is made of a conductor such as metal so that microwaves due to unnecessary sidelobes generated by the microwave beam are not leaked to the outside.

The plurality of antennas 7 is provided on a wall surface of the chamber 6 and performs spatial combining for the microwave beam 5 inside the chamber 6. The plurality of oscillators 8 supplies electrical signals of phase-controlled microwaves to the plurality of antennas 7, respectively. Each of the oscillators 8 includes an oscillation source and a semiconductor amplifier of GaN or the like. By matching the phases of the microwaves output from the plurality of antennas 7, the intensity of radio waves which are radiated to the outside is reduced, and the microwave beam 5 is concentrated in the center portion of the opening 3.

In general, regarding a magnetron, the phase is not stable and the frequency bandwidth is wide. Therefore, when microwaves fed from two or more magnetrons are combined, combined power and efficiency are significantly decreased due to combining loss.

In contrast to the magnetron, the microwave generator 4 enables phase-controlled microwaves to be emitted from the antennas 7. Thus, microwaves which are controlled in both phase and frequency bandwidth can be emitted from the respective antennas 7, and can undergo spatial combining. As a result, the microwave beam 5 of high output power can be obtained while the loss is reduced. For example, when microwaves are supplied with oscillators of 300 W to an array antenna including 100 antennas in a 10×10 array, the microwave beam 5 of 30 kW can be obtained. The efficiency of the microwave is determined by the efficiency of each of the antennas 7. Therefore, with an oscillator which uses a GaN amplifier, high efficiency of approximately 70% can be achieved, and it is possible to achieve high efficiency while obtaining a high output of 10 kW or more.

The spacing between the antennas 7 is about half of the wavelength, and accordingly, approximately 6 cm at 2.45 GHz. Hence, the size of the array antenna is approximately 60 cm×60 cm, which is a fully achievable size. In the present method, when the number of array antennas is increased, the power of the microwaves can be increased by spatial combining; therefore, it is easily achieved even with microwaves of 30 kW or more. For example, when an output of 1 MW at 2.45 GHz is needed, spatial combining may be performed on 3333 oscillators of 300 W. In the case where the antennas 7 are arranged in a rectangle, the arrangement is approximately 58×58, and when they are arranged with λ/2 spacing therebetween, each side is approximately 3.4 m, which can be fully achieved with a large reactor.

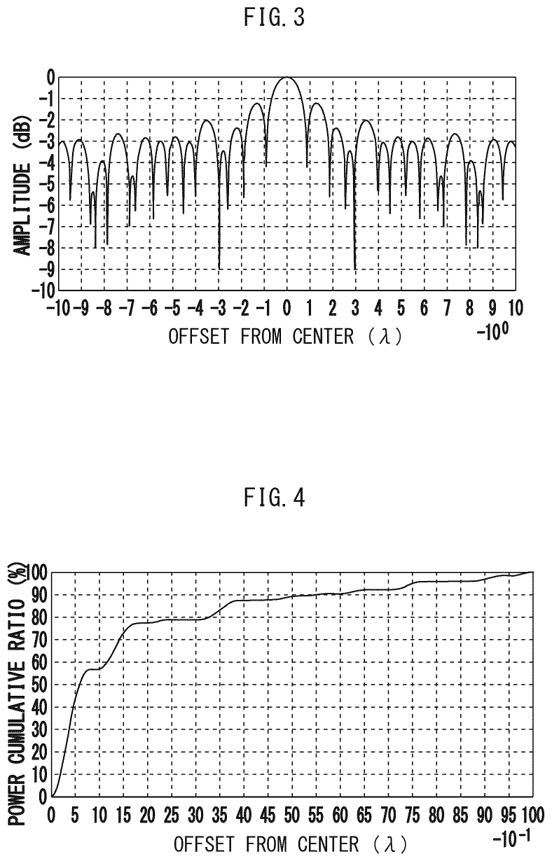

FIG. 3 and FIG. 4 show calculation results of spatial combining of microwaves from a rectangular array antenna. The rectangular array antenna is made such that 21×21 antennas 7 are arranged in a rectangle. The size of the rectangular array antenna is approximately 61 cm×61 cm. In FIG. 3, the amplitude of a microwave on a surface which is 82 apart from an antenna is expressed by dB. In FIG. 4, the ratio of cumulative power accumulated in accordance with a distance d from the center is expressed in units of 10%. The horizontal axis represents a distance from the center in units of wavelength 2. By referring to the power cumulative ratio, the proportion of the power of microwaves emitted to a circle with a radius of d from the center is found. Thus, it is shown from FIG. 4 that, for example, the proportion of microwaves which pass through the opening with a radius of 10λ is 57%.

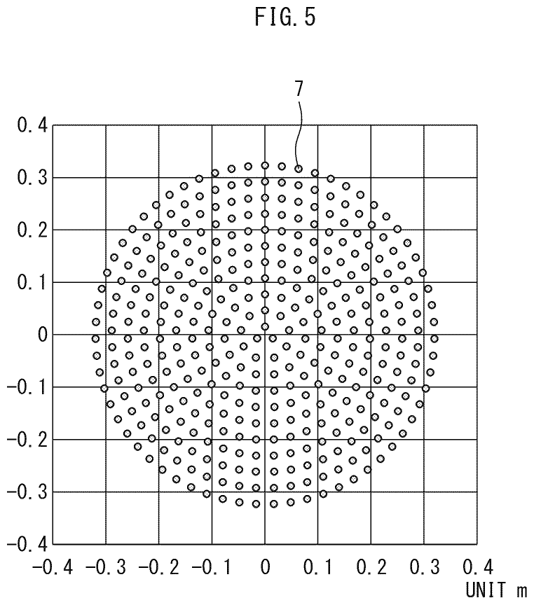

FIG. 5 shows a circular array antenna. The plurality of antennas 7 is arranged with approximately half wavelength spacing therebetween in a circular region. The number of the antennas is 363, which is almost the same as the number of the antennas in the rectangular array described above. With a circular array, microwaves can be more concentrated in the center portion of the opening 3 as compared with the rectangular array.

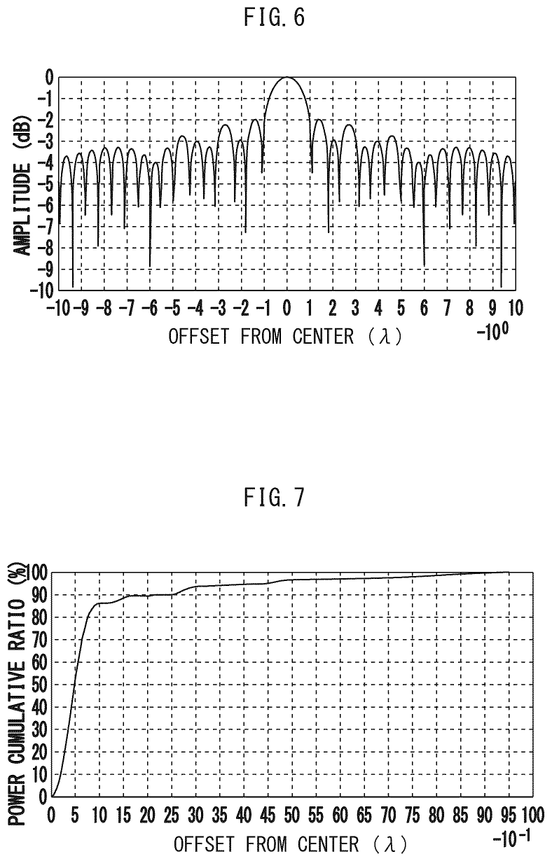

FIG. 6 and FIG. 7 show calculation results of spatial combining of microwaves from the circular array antenna. The diameter of the circular array is approximately 64 cm, which is almost the same as that of the rectangular array. In FIG. 6, the amplitude of a microwave on a surface which is 4.52 apart from an antenna is expressed by dB. In FIG. 7, the ratio of cumulative power accumulated in accordance with a distance d from the center is expressed in units of 10%. As shown in FIG. 6, the amplitude of a sidelobe of the circular array is reduced as compared with that of the rectangular array of FIG. 3. As shown in FIG. 7, the proportion of microwaves which go through the opening 3 with a radius of 10λ is increased to 86%. This indicates that the circular array is superior to the rectangular array in emitting more power through the opening 3. Note that because calculation is not performed on components which are reflected by a side wall of the chamber 6 to reach the opening 3 in the present calculation, a higher proportion of microwaves can be made to pass through the opening 3 in practice.

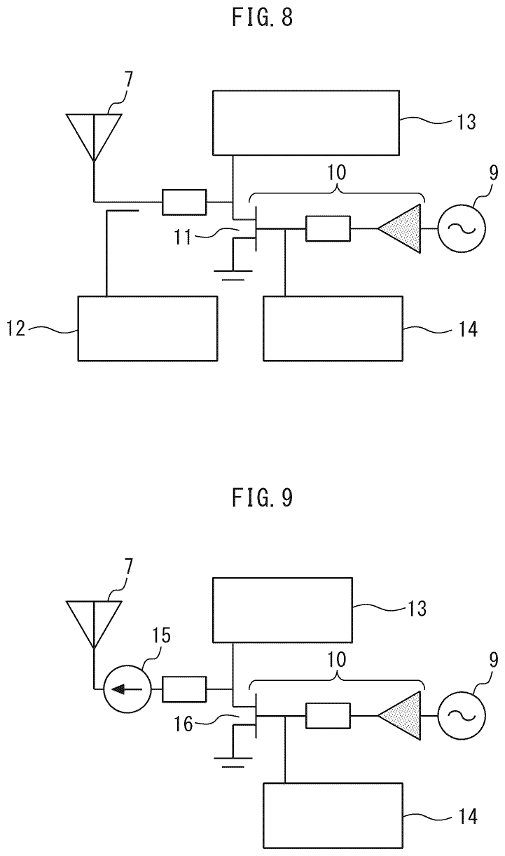

FIG. 8 is a circuit diagram of the oscillator of the microwave reactor according to Embodiment 3. The oscillator 8 includes: an oscillation source 9; an amplifier 10 including at least a single-stage transistor; and a reflected wave monitor circuit 12 connected between a last-stage transistor 11 of the amplifier 10 and the antenna 7. The oscillation source 9 generates an electrical signal of a microwave. The amplifier 10 amplifies the electrical signal of the microwave from the oscillation source 9. The last-stage transistor 11 of the amplifier 10 is a GaN transistor. The electrical signal amplified by the GaN transistor is supplied to the antenna 7. The antenna 7 emits a microwave.

A drain voltage control circuit 13 controls drain voltage of the last-stage transistor 11. A gate voltage control circuit 14 controls gate voltage of the last-stage transistor 11. The reflected wave monitor circuit 12 monitors the intensity of reflected waves returned from the antenna 7. The reflected wave monitor circuit 12 is configured by a circuit in which a detection diode is connected to a directional coupler, for example.

When the intensity of reflected waves exceeds a threshold value, the reflected wave monitor circuit 12 controls the drain voltage control circuit 13 so that the drain voltage of the last-stage transistor 11 is decreased immediately to 0 V or low voltage, or controls the gate voltage control circuit 14 so that the operating current of the last-stage transistor 11 is decreased. The threshold value for the intensity of the reflected waves to be used in performing such control may be the intensity which is half to several times as high as an output signal of the oscillator 8, for example.

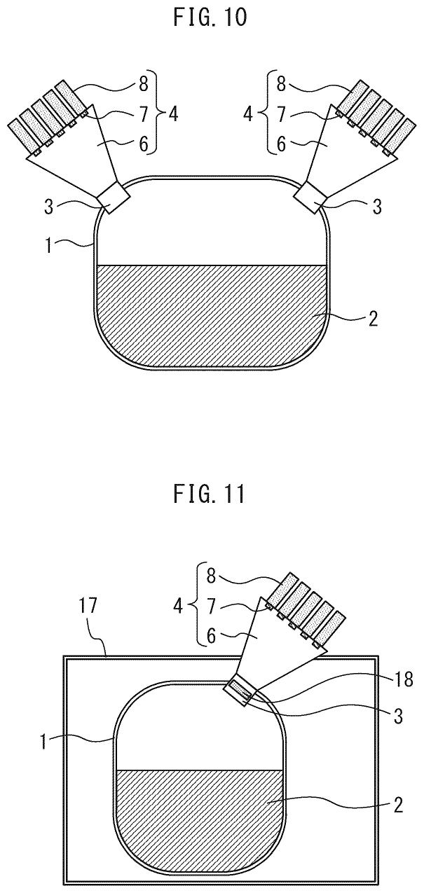

Next, the effect of this embodiment will be described while comparing with a comparison example. FIG. 9 is a circuit diagram of an oscillator according to the comparison example. In the comparison example, an isolator 15 is connected between an LDMOS transistor 16, which is a last-stage transistor of the amplifier 10, and the antenna 7.

In a manner like Embodiment 1, since the area of the opening 3 of the reactor 1 is made equal to or less than 1/10 of the area of the portion of the inner wall of the reactor 1 which is not covered with the reactant 2, a reflected wave from the reactor 1 is inhibited. However, due to an unexpected and sudden event such as not being filled with the reactant 2, for example, a large reflected wave enters the antenna 7 in some cases. By such an excessively large signal, the last-stage transistor 11 of the oscillator 8 or the like is damaged in some cases. To prevent this, the isolator 15 is provided in the comparison example. However, the isolator 15 is a magnetic circuit, and when the output is increased to 300 W, the size is increased and the cost is also increased. In addition, a resistor which changes a reflected wave to heat is included in the isolator 15. The size of the resistor is also increased to deal with high power. Furthermore, the resistor is burn-damaged in some cases when reflected power is large. Thus, the replacement of the isolator 15 is needed for restoration, which requires a great deal of time and cost.

In contrast, in this embodiment, the reflected wave monitor circuit 12 is provided between the last-stage transistor 11 of the amplifier 10 and the antenna 7. When a large reflected wave comes, the reflected wave monitor circuit 12 performs control so that the drain voltage or the operating current of the last-stage transistor 11 is decreased. Thus, it is possible to prevent the amplifier 10 connected to the antenna 7 from being damaged even when a large reflected wave is generated. Since it requires only changing the drain voltage or the operating current of the last-stage transistor 11, it is only necessary to return either of the voltages to the original value also for the restoration. Thus, it is possible to perform the restoration in a short time without component replacement.

In this embodiment, the reflected wave monitor circuit 12 is provided for each antenna 7. The configuration is not limited to this, and one reflected wave monitor circuit 12 may be provided for a plurality of antennas 7 and perform control so that the drain voltage or the operating current of all the last-stage transistors 11 of the plurality of oscillators 8 is decreased when a reflected wave comes from the antennas 7. For example, in the case of an array antenna of 10×10, the reflected wave monitor circuit 12 may be provided for one oscillator 8 in a block of 10 or 25 antennas 7 and collectively perform control so that the drain voltage or the operating current of all the last-stage transistors 11 in the same block is decreased. The collective control of the plurality of antennas enables reduction in the number of control devices, leading to cost reduction.

The microwave reactor is a closed space, not a free space, and the direction of the microwave beam is fixed. Thus, unlike an array antenna of a general radar or the like, reflection cannot enter only a specific one from outside, and a reflected wave enters over the whole. Accordingly, such a protection circuit provided in each block is also effective.

Furthermore, in this embodiment, the last-stage transistor 11 of the amplifier 10 is a GaN transistor. The GaN transistor has higher efficiency than a conventional LDMOS, so the energy efficiency of the microwave reactor can be improved. Also, since the GaN transistor has higher withstand voltage than an LDMOS and is hardly damaged by application of high voltage, it has a high tolerance to reflected waves.

### Embodiment 4

FIG. 10 is a cross-sectional view showing a microwave reactor according to Embodiment 4. The reactor 1 is provided with a plurality of openings 3. A plurality of microwave generators 4 concentrate microwave beams 5 in the center portions of a plurality of openings 3, respectively, to cause the microwave beams 5 to enter the inside of the reactor 1. Note that in the drawing, the number of the openings 3 and the number of the microwave generators 4 are each two, but the number is not limited thereto, and may each be three or more.

The size of each of the openings 3 is longer than the half wavelength of the microwave beam 5, and the area of each of the openings 3 is equal to or less than 1/10 of the area of the portion of the inner wall of the reactor 1 which is not covered with the reactant 2. The plurality of openings 3 are provided such that the microwaves caused to enter from each of the openings 3 are prevented from entering another opening 3 directly and being reflected by the inner wall of the reactor 1.

In the case where the reactor 1 is large or the power of the microwave is significantly high, a plurality of microwaves is supplied to the inside of the reactor 1 through the plurality of openings 3 as described above. However, since the reactor 1 is large, the distribution of an electromagnetic field by multiple reflection in the reactor becomes nonuniform. As a result, the microwaves with which the reactant 2 is irradiated do not become uniform, and the reaction does not proceed uniformly, thereby reducing yield or degrading reaction efficiency.

The microwaves which are caused to enter the inside of the reactor 1, which is a closed space, through each of the openings 3 are reflected multiple times, and a standing wave of an electromagnetic wave having a crest and a trough is generated. By changing the phase of the microwave, the crest and the trough of the standing wave can be changed. Also, the oscillator 8 can control the phase of the microwave precisely because it is an oscillator which uses a semiconductor such as GaN, though it has been difficult to control the phase of the microwave in a conventional magnetron.

In view of this, the oscillators 8 of the plurality of microwave generators 4 control the phases of the microwaves caused to enter from the plurality of openings 3, respectively, so that the microwave distribution (electromagnetic field distribution) inside the reactor 1 becomes uniform. Thus, the reactant 2 in the reactor can be uniformly irradiated with the microwaves; therefore, the reaction of the reactant 2 can be made uniform. Simulation may be performed in advance for optimal phase control, or conditions may be set to those for good yield with the phase changed.

### Embodiment 5

FIG. 11 is a cross-sectional view showing a microwave reactor according to Embodiment 5. An explosion protection wall 17 surrounds the reactor 1 to seal in the gas generated from the reactor 1. Since the oscillator 8 is provided outside the explosion protection wall 17, the oscillator 8 need not be protected from explosion and can be manufactured at low cost.

There is a possibility that the reactant 2 in the reactor 1 will be scattered or gasified to damage the antenna 7 of the microwave generator 4. Thus, a shielding plate 18 is provided for the opening 3 of the reactor 1. The shielding plate 18 prevents a substance inside the reactor 1 from exiting the reactor 1 from the opening 3. Therefore, the substance generated in the reactor 1 is not attached to the antenna 7 of the microwave generator 4, so that the antenna 7 can be prevented from being degraded. The microwave beam 5 can pass through the shielding plate 18.

The shielding plate 18 is a quartz plate having a thickness which is the half wavelength of the microwave beam 5. The microwave which passes through the shielding plate 18 is reflected by an upper surface and a lower surface of the shielding plate 18, but a reflected wave from the upper surface of the shielding plate 18 and a reflected wave from the lower surface thereof cancel each other out. Hence, it is possible to prevent a decrease in the feeding amount of a microwave due to unnecessary reflection.

Note that the shielding plate 18 is not limited to a quartz plate and may be a dielectric plate through which a microwave can pass, such as glass, resin, or the like, or may be a dielectric plate in which a fibrous material is used. The shielding plate 18 is not limited to one dielectric plate and may be a plurality of dielectric plates.

### Embodiment 6

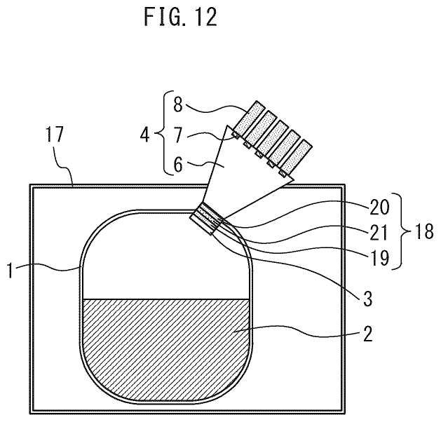

FIG. 12 is a cross-sectional view showing a microwave reactor according to Embodiment 6. The shielding plate 18 in Embodiment 5 is a quartz plate, and thus, heat is generated by tan δ of quartz by the passage of a microwave. When calculation is performed on the amount of heat generation due to a dielectric loss when tan δ of quartz is 0.00025 at 2.45 GHz, 78 W is obtained with 100 kW, and the temperature rise is approximately 200° C. Therefore, the usable range is up to approximately 100 kW, but with a high power of 1 MW or more, the heat generation is 780 W or more and the temperature rise is 2000° C. or more, and a possibility of causing damage arises. This heat generation is due to the dielectric loss of the quartz plate; therefore, by making the thickness of the quartz plate sufficiently smaller than the half wavelength, the dielectric loss can be decreased. However, there is a risk of damage to the thin film of quartz due to the difference between the pressures inside and outside the reactor.

In view of this, in this embodiment, the shielding plate 18 includes two dielectric thin films 19 and 20 and a honeycomb member 21 which is sandwiched between the two dielectric thin films 19 and 20 and has a thickness of a ¼ wavelength of the microwave beam 5. The dielectric thin films 19 and 20 are quartz thin films each having a plate thickness sufficiently smaller than the half wavelength. Thus, it is possible to prevent unnecessary heat generation.

The honeycomb member 21 is a dielectric having a relative dielectric constant that is close to 1 and has little influence on the microwave, e.g., glass fiber reinforced plastic or the like. When two dielectric thin films 19 and 20 are provided to be apart with ¼ wavelength spacing therebetween, reflected waves can cancel each other out. Thus, it is possible to prevent a decrease in the feeding amount of microwaves due to unnecessary reflection. In addition, by providing the honeycomb member 21 between the two dielectric thin films 19 and 20, the quartz thin films can be supported in terms of strength against the pressure applied from the reactor 1.

Note that the dielectric thin films 19 and 20 are not limited to quartz thin films and may be dielectric thin films through which a microwave can pass, such as glass, resin, or the like, or may be dielectric thin films in which a fibrous material is used. The dielectric thin films 19 and 20 are not limited to two thin films and may be a plurality of thin films.

### REFERENCE SIGNS LIST

1 reactor; 2 reactant; 3 opening; 4 microwave generator; 5 microwave beam; 6 chamber; 7 antennas; 8 oscillator; 10 amplifier; 11 last-stage transistor; 12 reflected wave monitor circuit; 18 shielding plate; 19,20 dielectric thin film; 21 honeycomb member

1. A microwave reactor comprising:
a reactor accommodating a reactant; and
a microwave generator generating a microwave beam,
wherein an opening is provided in the reactor,
the microwave generator concentrates the microwave beam in a center portion of the opening to cause the microwave beam to enter an inside of the reactor,
an inner wall of the reactor reflects the microwave beam,
a size of the opening is longer than a half wavelength of the microwave beam, and
an area of the opening is equal to or less than 1/10 of an area of a portion of the inner wall of the reactor which is not covered with the reactant.

2. The microwave reactor according to claim 1, wherein the microwave generator causes the microwave beam to enter the inside of the reactor directly without using a waveguide.

3. The microwave reactor according to claim 1, wherein the microwave generator includes
a chamber connected to the opening, made of a conductor, and surrounding a space for forming the microwave beam,
a plurality of antennas provided on a wall surface of the chamber and performing spatial combining for the microwave beam inside the chamber, and
a plurality of oscillators supplying electrical signals of phase-controlled microwaves to the plurality of antennas, respectively.

4. The microwave reactor according to claim 3, wherein the plurality of antennas construct a circular array antenna.

5. The microwave reactor according to claim 3, wherein the oscillator includes an amplifier including at least a single-stage transistor and amplifying an electrical signal of the microwave, and a reflected wave monitor circuit connected between a last-stage transistor of the amplifier and the antenna,
the reflected wave monitor circuit monitors an intensity of a reflected wave returned from the antenna, and
when an intensity of the reflected wave exceeds a threshold value, the reflected wave monitor circuit controls to decrease drain voltage or an operating current of the last-stage transistor.

6. The microwave reactor according to claim 5, wherein when the intensity of the reflected wave exceeds the threshold value, the reflected wave monitor circuit controls to decrease drain voltage or operating currents of all the last-stage transistors of the plurality of oscillators

7. The microwave reactor according to claim 5, wherein the last-stage transistor is a GaN transistor.

8. The microwave reactor according to claim 3, wherein a plurality of the openings are provided in the reactor,
the plurality of openings are provided such that the microwaves caused to enter from the openings are prevented from entering another opening directly and being reflected by the inner wall of the reactor, and
the plurality of oscillators control phases of the microwaves caused to enter from the plurality of openings, respectively, so that a microwave distribution inside the reactor becomes uniform.

9. The microwave reactor according to claim 1, further comprising a shielding plate provided for the opening of the reactor and preventing a substance inside the reactor from exiting the reactor from the opening.

10. The microwave reactor according to claim 9, wherein the shielding plate is a dielectric plate having a thickness which is a half wavelength of the microwave beam.

11. The microwave reactor according to claim 9, wherein the shielding plate includes two dielectric thin films and a honeycomb member which is sandwiched between the two dielectric thin films and has a thickness of a ¼ wavelength of the microwave beam.
